(19) United States
(12) Patent Application Publication
(10) Pub. No.: US 2007/0064204 A1
(43) Pub. Date: Mar. 22, 2007

(54) IMAGE DISPLAY APPARATUS, AND PROJECTION SYSTEM

(75) Inventors: Yasunaga MIYAZAWA, Suwa-shi, Nagano-ken (JP); Hiroshi HASEGAWA, Suwa-shi, Nagano-ken (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 11/533,656

(22) Filed: Sep. 20, 2006

(30) Foreign Application Priority Data
Sep. 21, 2005 (JP) 2005-273707

(51) Int. Cl. G03B 21/28

(52) U.S. Cl. 353/98

(57) ABSTRACT

An image display apparatus that displays input image data includes: a light source unit; a light modulating device that has liquid crystal elements arranged in a matrix, each modulating light emitted from the light source unit in response to a driving signal in every pixel; a driving control unit that controls the driving of the light source unit and the light modulating unit; a motion determining unit that compares a variation between current image data and previous image data with a predetermined threshold value, sets the current image data to large motion image data when the variation is larger than the threshold value, and sets the current image data to small motion image data when the variation is smaller than the threshold value; and a visibility improving unit that drives the driving control unit to perform a visibility improving process when the current image data that has been determined as the large motion image data by the motion determining unit is displayed.

### BACKGROUND

1. Technical Field

The present invention relates to an image display apparatus, and a projection system. More specifically, the invention relates to a technique for improving the visibility of an image when an image display device provided with liquid crystal elements having holding characteristics displays images.

2. Related Art

In recent years, image display apparatuses each having a light source and a light modulating unit for modulating light emitted from the light source have been known. For example, a projection-type display apparatus that has a backlight and a liquid crystal panel and projects an image onto a screen has been known. The liquid crystal panel includes scanning signal lines, data signal lines arranged orthogonal to the data lines, and liquid crystal elements that are arranged in a matrix and are provided at intersections of the scanning signal lines and the data signal lines. When scanning signals and data signals are supplied to the scanning signal lines and the data signal lines on the basis of image data, respectively, and thus the liquid crystal elements are driven, the alignment of the liquid crystal elements is controlled. Then, light is emitted from the backlight to each pixel, which causes a predetermined image to be displayed.

Liquid crystal has a capacitive load, and holds an alignment state that is varied depending to a signal voltage (hold characteristic). Therefore, the display device using the liquid crystal has an advantage in that it can display a high-definition image, as compared with, for example, a CRT. In contrast, the liquid crystal has a low response speed and thus does not respond to an input image signal at a sufficiently high speed in one frame period of the input image signal. Therefore, when a moving picture is displayed, a residual image occurs, which causes the deterioration of display quality.

In order to solve the problem of the display quality being deteriorated due to the holding characteristics of the liquid crystal, a method of inserting black display (blanking) in the period of one frame to improve the visibility of a moving picture has been proposed (JP-A-2004-309657). For example, in displaying one frame, signals are scanned on the liquid crystal panel with the backlight turned off in the first half of one frame, and the backlight is turned on in the second half of one frame in which the liquid crystal is stabilized. The black display is inserted in the period for which the liquid crystal is held by driving the light source in an intermittent driving manner in which the backlight is turned on or off in the first half or the second half of one frame. Then, the human eye is reset, and thus the residual image does not persist in the human eye, which makes it possible to improve the visibility of a moving picture.

However, when a process of improving the visibility of a moving picture is performed, the light source should be intermittently driven at an excessively high rate. When the intermittent driving of the light source is continuously performed, a large load is applied to the light source, which causes the life span of the light source to be excessively shortened. Therefore, it is actually difficult to continuously perform the process of improving the visibility of a moving picture. As a result, in the display apparatus using the liquid crystal panel, the residual image persists when scenes are rapidly changed, which results in the deterioration of display quality.

### SUMMARY

An advantage of some aspects of the invention is that it provides an image display apparatus, a projection system, and an information processing apparatus capable of appropriately improving the visibility of a moving picture, a method of driving an image display apparatus, a program for driving an image display apparatus, and a storage medium.

According to an aspect of the invention, an image display apparatus that displays input image data includes: a light source unit; a light modulating device that has liquid crystal elements arranged in a matrix, each modulating light emitted from the light source unit in response to a driving signal in every pixel; a driving control unit that controls the driving of the light source unit and the light modulating unit; a motion determining unit that compares a variation between current image data and previous image data with a predetermined threshold value, sets the current image data to large motion image data when the variation is larger than the threshold value, and sets the current image data to small motion image data when the variation is smaller than the threshold value; and a visibility improving unit that drives the driving control unit to perform a visibility improving process when the current image data that has been determined as the large motion image data by the motion determining unit is displayed.

In the above-mentioned structure, when the image data is input to the image display apparatus, the driving control unit drives the liquid crystal elements of the light modulating device on the basis of the image data, and light emitted from the light source unit is modulated by each pixel. In this way, an image is displayed.

The motion determining unit determines the degree of motion from the previous image to the current image. That is, the motion determining unit compares the variation between the current image and the previous image with a predetermined threshold value, and determines that the current image data is large motion image data having large motion when the variation is larger than the threshold value. When the current image data that has been determined as the large motion image data is displayed, the visibility improving unit performs the visibility improving process. In the visibility improving process, for example, black display is inserted in one frame. Then, the black display is inserted in the period for which the liquid crystal elements are held, and thus the residual image does not persist in the human eye, resulting in an improvement in the visibility of an image.

According to the above-mentioned structure, since the motion determining unit is provided, it is possible to determine whether the current image data is largely changed from the previous image data.

Only when the current image data is the large motion image data, the visibility improving process is performed on the basis of the determination by the motion determining unit, which makes it possible to improve the visibility of an image. In the related art, when the image display apparatus displays a high-quality image, the visibility improving process is performed on all the images. Therefore, when the intermittent driving of a light source is performed to improve the visibility of an image, the life span of the light source is shortened.

In contrast, in the aspect of the invention, only when the current image data that has been determined as the large motion image data by the motion determining unit is displayed, the visibility improving process is performed, and an image is displayed. Therefore, even when the intermittent driving of a light source is performed to improve the visibility of an image, it is possible to reduce a load applied to the light source, and to appropriately perform the visibility improving process to improve the display quality of an image.

In the image display apparatus according to the above-mentioned embodiment, preferably, the visibility improving unit intermittently drives the light source unit while one frame of image data is being displayed, so that black display is inserted in one frame.

According to the above-mentioned structure, the black display (blanking) is inserted in the period of one frame. That is, when image data is written to the light modulating device, the black display is inserted in the period for which the liquid crystal is held. The liquid crystal elements are stabilized, and the light source is turned on, thereby displaying an image. For example, when one frame of image data is displayed, the image data is written to the light modulating device with the light source turned off in the first half of one frame. On the other hand, the light source is turned on in the second half of one frame in which the liquid crystal is stabilized. Then, the human eye is reset, and the residual image does not persist, which makes it possible to improve the visibility of an image.

Further, the writing of data for black display as well as the intermittent driving of the light source may be performed as the visibility improving process.

According another aspect of the invention, a projection system includes: an information processing apparatus that performs predetermined image processing on an input image source to output an image data signal; an image display apparatus that includes a light source unit, a light modulating device which has liquid crystal elements arranged in a matrix, each modulating light emitted from the light source unit in response to a driving signal in every pixel, and a driving control unit which controls the driving of the light source unit and the light modulating unit, and displays the image source input from the information processing apparatus; and a signal transmitting unit that transmits signals between the information processing apparatus and the image display apparatus. In the projection system, the information processing apparatus includes a differential data generating unit that compares current image data with previous image data and detects a variation between the current image data and the previous image data as differential data. The image display apparatus includes: a motion determining unit that compares the amount of the differential data with a predetermined threshold value, sets the current image data to large motion image data when the amount of the differential data is larger than the threshold value, and sets the current image data to small motion image data when the amount of the differential data is smaller than the threshold value; and a visibility improving unit that drives the driving control unit to perform a visibility improving process when the current image data that has been determined as the large motion image data by the motion determining unit is displayed.

According to the above-mentioned structure, the information processing apparatus performs predetermined image processing on the image data, and the differential data generating unit generates the differential data. The signal transmitting unit transmits the differential data to the image display apparatus. In the image display apparatus, the motion determining unit compares the amount of the differential data with the threshold value. When the amount of the differential data is larger than the threshold value, the motion determining unit determines that the variation between the current image data and the previous image data is large, and the current image data is set to the large motion image data. In the display of the current image data, which is the large motion image data, the visibility improving unit performs the visibility improving process, such as the intermittent driving of the light source.

According to the above-mentioned structure, the information processing apparatus performs necessary image processing, and transmits the image data signal to the image display apparatus. Therefore, the image display apparatus does not need to have a complicated image processing function, which makes it possible to simplify the structure of the image display apparatus. For example, when a personal computer is used as the information processing apparatus, it is possible to use the graphic function of the personal computer, which makes it unnecessary to additionally provide an image processing function. The graphic processing function of the personal computer makes it possible to accurately perform image processing at high speed.

Since the differential data, not one image frame, is transmitted from the information processing apparatus to the image display apparatus, it is possible to reduce the amount of transmission data and thus to appropriately keep the frame rate of the image to be displayed by the image display apparatus.

Since the image display apparatus includes the motion determining unit, the image display apparatus can determine whether the current image data is largely changed from the previous image data on the basis of the differential data. Therefore, only when the current image data that has been determined as the large motion image data by the motion determining unit is displayed, the visibility improving process is performed to improve the visibility of an image. Thus, even when the intermittent driving of the light source is performed to improve the visibility of an image, it is possible to reduce a load applied to the light source, and to appropriately perform the visibility improving process to improve the display quality of an image.

The differential data is transmitted from the information processing apparatus, and the motion determining unit of the image display apparatus uses the differential data to determine the degree of motion of the current image data.

The differential data is used to reduce the amount of data transmitted between the information processing apparatus and the image display apparatus. However, the differential data can be used to determine the degree of motion.

Therefore, according to the aspect of the invention, it is possible to simply execute the invention without changing the structure of the information processing apparatus.

According to still another aspect of the invention, a projection system includes: an information processing apparatus that performs predetermined image processing on an input image source to output an image data signal; an image display apparatus that includes a light source unit, a light modulating device which has liquid crystal elements arranged in a matrix, each modulating light emitted from the light source unit in response to a driving signal in every pixel, and a driving control unit which controls the driving of the light source unit and the light modulating unit, and displays the image source input from the information processing apparatus; and a signal transmitting unit that transmits signals between the information processing apparatus and the image display apparatus. In the projection system, the information processing apparatus includes a motion determining unit that compares a variation between current image data and previous image data, and raises a flag for allowing the current image data to be set to large motion image data when the variation is larger than the threshold value. The image display apparatus includes: a flag detecting unit that detects the flag raised by the motion determining unit; and a visibility improving unit that drives the driving control unit to perform a visibility improving process when the current image data that has been determined as the large motion image data by the motion determining unit is displayed.

In the abovementioned structure, the information processing apparatus performs predetermined image processing on the image data, and the motion determining unit compares the variation between the current image data and the previous image data with a predetermined threshold value. When the variation is larger than the threshold value, a flag for setting the current image data to the large motion image data. The image data is transmitted from the information processing apparatus to the image display apparatus with the flag being raised. In the image display apparatus, the flag detecting unit detects the flag. Since the raised flag means that the current image data is the large motion image data, the visibility improving unit performs the visibility improving process, such as the intermittent driving of the light source, on the current image data having the raised flag.

According to the above-mentioned structure, this aspect can have the same effects as the above-mentioned embodiments. Further, the information processing apparatus determines the degree of motion, and the image display apparatus detects the flag, which makes it possible to simplify the structure of the image display apparatus.

For example, when an image source is represented by a motion vector, the motion determining unit may compare the magnitude of the motion vector with a predetermined threshold value.

Alternatively, when the information processing apparatus generates differential data and outputs the differential data to the image display apparatus, the motion determining unit may compare the amount of the differential data with a threshold value and transmit the differential data to the image display apparatus with a flag being raised.

According to yet another aspect of the invention, there is provided an information processing apparatus that outputs an image data signal to an image display apparatus for displaying input image data such that the image display apparatus displays an image. The image display apparatus includes: a light source unit; a light modulating device that has liquid crystal elements arranged in a matrix, each modulating light emitted from the light source unit in response to a driving signal in every pixel; and a driving control unit that controls the driving of the light source unit and the light modulating unit. The information processing apparatus includes a motion determining unit that compares a variation between current image data and previous image data, and raises a flag for allowing the current image data to be set to large motion image data when the variation is larger than the threshold value.

According to the above-mentioned structure, it is possible to provide an information processing apparatus capable of being appropriately used for the projection system.

According to still yet another aspect of the invention, there is provided a method of driving an image display apparatus for displaying input image data. The image display apparatus includes: a light source unit; a light modulating device that has liquid crystal elements arranged in a matrix, each modulating light emitted from the light source unit in response to a driving signal in every pixel; and a driving control unit that controls the driving of the light source unit and the light modulating unit. The method includes: comparing a variation between current image data and previous image data with a predetermined threshold value; setting the current image data to large motion image data when the variation is larger than the threshold value; setting the current image data to small motion image data when the variation is smaller than the threshold value; and driving the driving control unit to perform a visibility improving process when the current image data that has been determined as the large motion image data in the setting of the current image data is displayed.

According to the above-mentioned structure, this aspect can have the same effects as the above-mentioned aspects. That is, since the determining of the degree of motion is provided, it is possible to determine the current image whose motion is largely changed from the motion of the previous image. Only when the current image data that has been determined as the large motion image data by the motion determining unit is displayed, the visibility improving process is performed to display an image. Therefore, even when the intermittent driving of the light source is performed as the visibility improving process, it is possible to reduce the load applied to the light source and to appropriately perform the visibility improving process, which makes it possible to improve the display quality of an image.

According to still yet another aspect of the invention, there is provided a program that drives an image display apparatus for displaying input image data. The image display apparatus includes: a light source unit; a light modulating device that has liquid crystal elements arranged in a matrix, each modulating light emitted from the light source unit in response to a driving signal in every pixel; and a driving control unit that controls the driving of the light source unit and the light modulating unit. The program allows a computer to execute the functions of: comparing a variation between current image data and previous image data with a predetermined threshold value; setting the current image data to large motion image data when the variation is larger than the threshold value; setting the current image data to small motion image data when the variation is smaller than the threshold value; and driving the driving control unit to perform a visibility improving process when the current image data that has been determined as the large motion image data in the setting of the current image data is displayed.

According to yet still another aspect of the invention, a storage medium has the above-mentioned program for driving an image display apparatus stored therein.

According to the above-mentioned structure, this aspect can have the same effects as the above-mentioned aspects.

That is, it is possible to determine the current image whose motion is largely changed from the previous image in the determining of the degree of motion. Only when the current image data that has been determined as the large motion image data is displayed, the visibility improving process can be performed to display an image.

Therefore, even when the intermittent driving of the light source is performed as the visibility improving process, it is possible to reduce the load applied to the light source and to appropriately perform the visibility improving process, which makes it possible to improve the display quality of an image.

For example, the image display apparatus or the projection system may be provided with a CPU and a memory so as to function as a computer, and a predetermined program is installed in the memory through a communication apparatus, such as the Internet, or a storage medium, such as a CD-ROM or a memory card. Then, the installed program may allow the CPU to perform various processes. A memory card or a CD-ROM may be directly inserted into the image display apparatus or the projection system to install the program, or an apparatus for reading out data from the storage medium may be connected to an electronic apparatus to install the program. Alternatively, a program may be installed in the image display apparatus or the projection system through a wired network using, for example, a LAN cable or a telephone line, or it may be installed in the image display apparatus or the projection system through a wireless network.

### BRIEF DESCRIPTION OF THE DRAWINGS

The invention will be described with reference to the accompanying drawings, wherein like numbers reference like elements.

FIG. 1 is a layout view of a projection system according to a first embodiment of the invention.

FIG. 2 is a functional block diagram illustrating a personal computer according to the first embodiment of the invention.

FIG. 3 is a functional block diagram illustrating a projector according to the first embodiment of the invention.

FIG. 4 is a diagram illustrating the structure of an image projecting unit according to the first embodiment of the invention.

FIG. 5 is a flow chart illustrating a process of projecting image data onto the projector according to the first embodiment of the invention.

FIGS. 6A and 6B are timing charts of signals output from a driving control unit to the image projecting unit according to the first embodiment.

FIGS. 7A and 7B are diagrams illustrating signal writing aspects on a liquid crystal panel according to the first embodiment of the invention.

FIGS. 8A to 8C are diagrams illustrating signal writing aspects on the liquid crystal panel according to the first embodiment of the invention.

FIG. 9 is a functional block diagram illustrating a personal computer according to a second embodiment of the invention.

FIG. 10 is a functional block diagram illustrating a projector according to a second embodiment of the invention.

FIGS. 11A to 11C are diagrams illustrating a modification of a visible improving process.

### DESCRIPTION OF EXEMPLARY EMBODIMENTS

Hereinafter, preferred embodiments of the invention will be described with reference the accompanying drawings and components having reference numerals shown in the drawings.

### First Embodiment

A projection system according to a first embodiment of the invention will be described below.

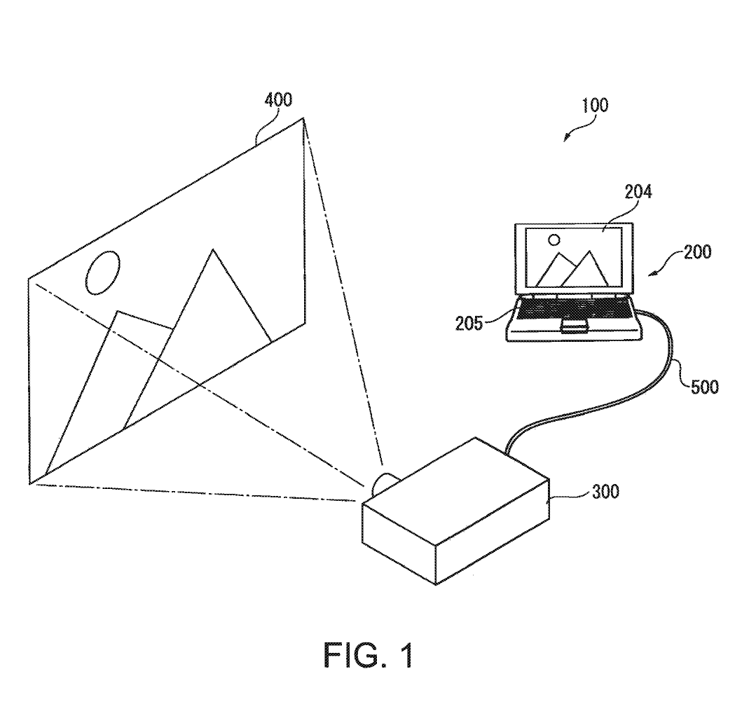

FIG. 1 is a layout view illustrating a projection system 100. The projection system 100 includes a personal computer (information processing apparatus) 200 for performing a predetermined image process on an image, which is an image source, to output image data signals, a projector (image display apparatus) 300 for generating a current image frame on the basis of the image data signals from the personal computer 200 and projecting the generated image frame onto a screen 400, and a USB cable (signal transmitting member) 500 for connecting the projector 300 to the personal computer

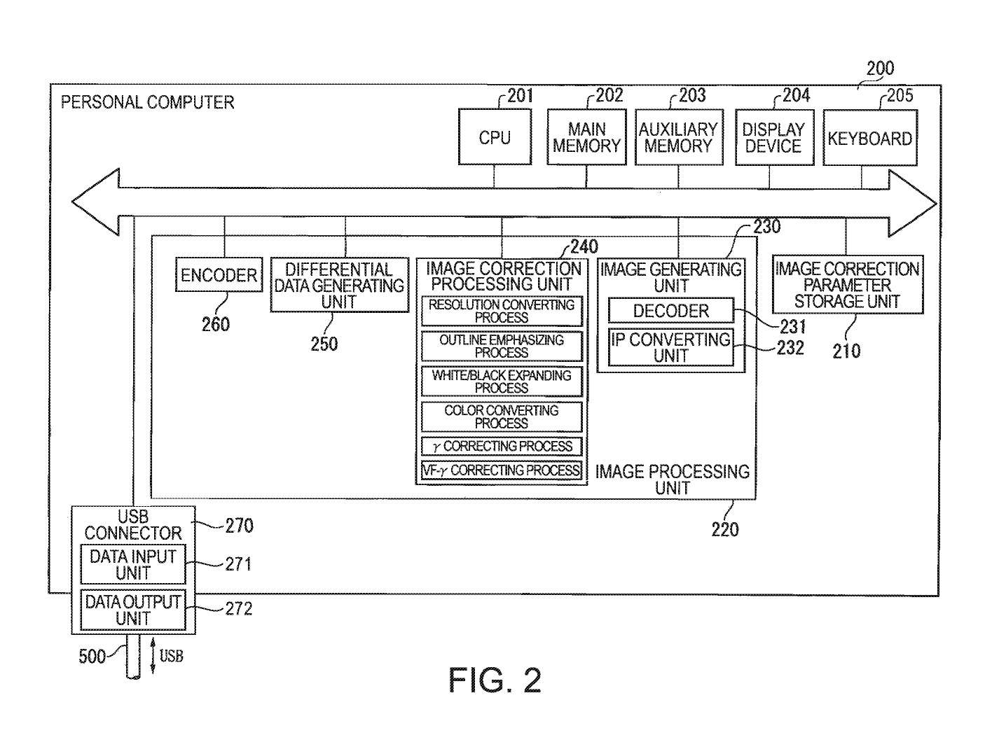

FIG. 2 is a functional block diagram illustrating the personal computer 200.

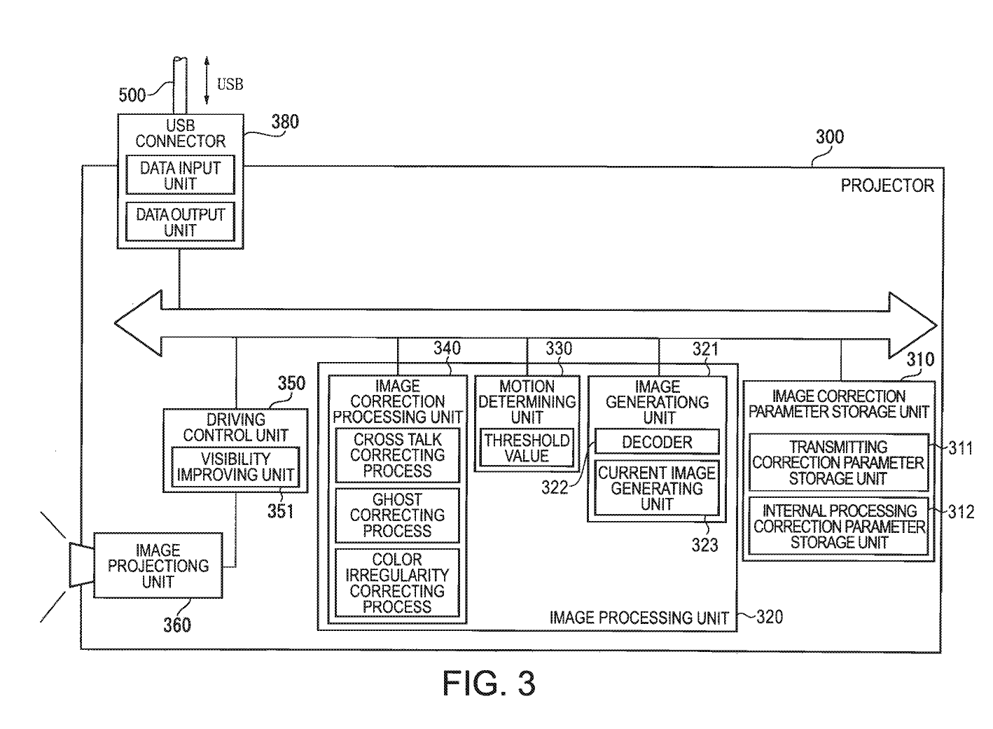

FIG. 3 is a functional block diagram illustrating the projector 300.

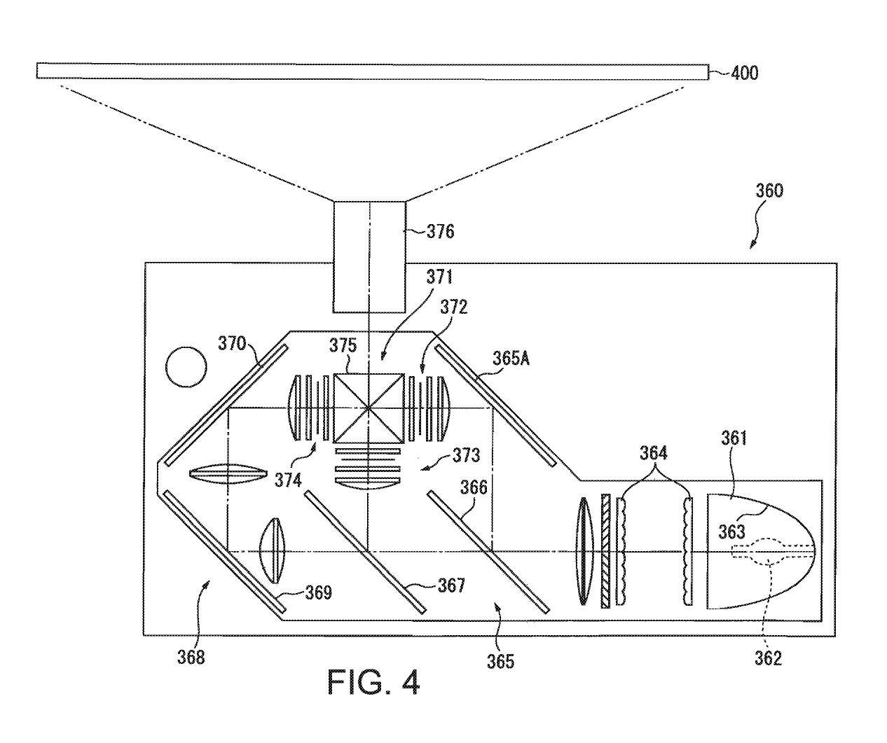

FIG. 4 is a diagram illustrating the structure of an image projecting unit 360.

As shown in FIG. 2, the personal computer 200 includes a CPU 201, a main memory 202, an auxiliary memory 203, a display device 204, a keyboard 205, an image correction parameter storage unit 210, an image processing unit 220, and a USB connector 270.

A medium, which is an image source, is used as the auxiliary memory 203. For example, a DVD (digital versatile disc) having image and audio data recorded thereon is used as the medium.

The image correction parameter storage unit 210 stores correction parameters for correcting images according to the characteristics of the projector 300. For example, various parameters for performing, for example, resolution conversion, outline emphasis, white/black expansion, color conversion, γ correction, and VT-γ correction are stored in the image correction parameter storage unit 210.

A memory card or a CD-ROM having these parameters stored therein may be inserted into the personal computer 200, and these parameters may be installed the image correction parameter storage unit 210. When the personal computer 200 and the projector 300 are connected to each other by the USB cable 500, the personal computer 200 may read out a predetermined parameter from the projector 300 and store the read parameter in the image correction parameter storage unit 210.

The image processing unit 220 includes an image generating unit 230, an image correction processing unit 240, a differential data generating unit 250, and an encoder 260.

The image generating unit 230 includes a decoder 231 and an IP converting unit 232, and decompresses the image source from the auxiliary memory 203 on the basis of a recording mode to decode image frame data one by one.

The image correction processing unit 240 corrects the image generated by the image generating unit 230 on the basis of the characteristics of the projector. For example, the correction process includes a resolution converting process, an outline emphasizing process, a white/black expanding process, a color converting process, γ correcting process, and a VT-γ correcting process.

The differential data generating unit 250 compares the latest image data with the previous image data among the image data corrected by the image correction processing unit 240 and detects the difference between the latest image and the previous image as differential data. That is, the differential data includes spatial variation and color variation between the latest image data and the previous image data.

The encoder 260 encodes the differential data generated by the differential data generating unit 250. The USB connector 270 includes a data input unit 271 and a data output unit 272, and inputs/outputs data from/to the projector 300 through the USB cable 500.

As shown in FIG. 3, the projector 300 includes an image correction parameter storage unit 310, an image processing unit 320, a driving control unit 350, an image projecting unit 360, and a USB connector 380.

The image correction parameter storage unit 310 includes a transmitting correction parameter storage unit 311, and an internal processing correction parameter storage unit 312. The transmitting correction parameter storage unit 311 stores parameters used for image correction by the personal computer 200, and the internal processing correction parameter storage unit 312 stores parameters used for image processing by the projector.

For example, parameters for resolution conversion, outline emphasis, white/black expansion, color conversion, γ correction, and VT-γ correction are stored in the transmitting correction parameter storage unit 311.

When the personal computer 200 and the projector are connected to each other by the USB cable 500, the personal computer 200 reads out information of the parameters stored in the transmitting correction parameter storage unit 311 and stores the read information in the image correction parameter storage unit 210. For example, parameters for cross talk correction, ghost correction, and color irregularity correction are stored in the internal processing correction parameter storage unit 312.

The image processing unit 320 includes an image generating unit 321, a motion determining unit 330, and an image correction processing unit 340.

The image generating unit 321 includes a decoder 322 and a current image generating unit 323.

The decoder 322 demodulates the image data signal transmitted from the personal computer 200.

That is, the image data signal transmitted from the personal computer 200 is encoded by the encoder 260 and is then demodulated by the decoder 322, thereby obtaining the differential data.

The current image generating unit 323 synthesizes the differential data with the image data being currently projected to generate a new current image frame.

The motion determining unit 330 determines whether the variation between the current image data and the previous image data is large, on the basis of the differentia data. A threshold value is set in the motion determining unit 330 beforehand, and the motion determining unit 330 compares the amount of the differential data transmitted from the personal computer 200 with the threshold value. When the amount of differential data is larger than the threshold value, the motion determining unit 330 determines that motion is large, and regards the current image data generated on the basis of the differentia data as a large moving picture frame. On the other hand, when the amount of differential data is smaller than the threshold value, the motion determining unit 330 determines that motion is small, and regards the current image data generated on the basis of the differentia data as a small moving picture frame.

The image correction processing unit 340 performs, for example, various correction processes, such as a cross talk correcting process, a ghost correcting process, and a color irregularity correcting process, on the current image data generated by the current image generating unit 323.

The driving control unit 350 output a control signal for driving the image projecting unit 360 to display the current image frame. The driving control unit 350 includes a visibility improving unit 351. When the current image data is a large moving picture frame, the driving control unit 350 drives the visibility improving unit 351 to perform a visibility improving process on the current image frame.

On the other hand, when the current image data is a small moving picture frame, the driving control unit 350 stops the visibility improving unit 351.

The detailed description of the visibility improving process will be described later.

As shown in FIG. 4, the image projecting unit 360 includes a light source unit 361. Light emitted from a light source 362 is collimated into a beam by a reflector 363, and the collimated beam passes through two lens arrays 364 and travels toward a color separating optical system 365.

The color separating optical system 365 a dichroic mirror 366 for reflecting a red light beam and transmitting blue and green light beams and a dichroic mirror 367 for reflecting the green light beam and transmitting the blue light beam. The color separating optical system 365 separates light into red, green, and blue light beams. The red light beam is reflected from a reflecting mirror 365A, the green light beam is reflected from the dichroic mirror 367, and the blue light beam is guided to a relay optical system 368 including two reflecting mirrors 369 and 370. Then, the three light beams are incident on a red liquid crystal panel (light modulating device) 372, a green liquid crystal panel (light modulating device) 373, and a blue liquid crystal panel (light modulating unit) 374 of an electro-optical device 371, respectively. The incident light beams are optically modulated in the liquid crystal panels 372 to 374 on the basis of image information, and the modulated light beams are combined into an image by a prism 375.

The combined image is emitted from a projection optical system 376, is enlarged, and is then projected on the screen 400.

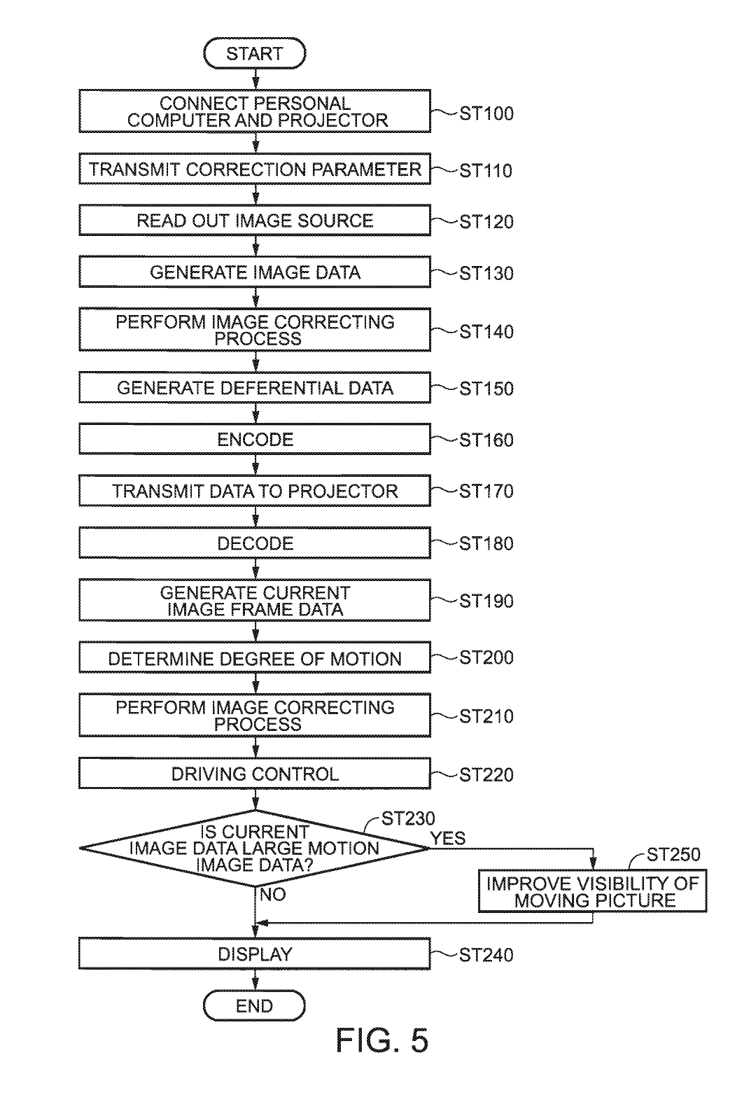

The first embodiment having the above-mentioned structure will be described below with reference to the flow chart shown in FIG. 5.

First in step ST100, the personal computer 200 and the projector 300 are connected to each other by the USB cable 500. In step ST110, various correction parameters stored in the transmitting correction parameter storage unit 311 of the projector 300 are transmitted to the personal computer 200 through the USB cable 500, and are then stored in the image correcting parameter storage unit 210 of the personal computer 200.

In step ST120, the image source is read out from the DVD of the auxiliary memory 203. Then, in step ST130, the image generating unit 230 performs decoding or IP conversion on the image source to generate image data.

In step ST140, the image correction processing unit 340 performs an image correcting process on the image data. That is, the image correction processing unit 340 performs, for example, a resolution converting process, an outline emphasizing process, a white/black expanding process, a color converting process, a γ correcting process, and a VT-γ correcting process on the image data.

The corrected image data is sequentially transmitted to the differential data generating unit 250. In step ST150, the differential data generating unit 250 compares the previous image and the latest image. The spatial and color variations between the previous image and the latest image are detected as differential data.

In step ST160, the differential data generated by the differential data generating unit 250 is encoded by the encoder 260. In step ST170, the encoded differential data is transmitted to the projector 300 through the USB cable 500.

In step ST180, the data signals of the transmitted differential data are demodulated by the decoder 322. In step ST190, the current image generating unit 323 synthesizes the demodulated differential data with the current image frame data being currently projected to generate the next current image frame.

In step ST200, the motion determining unit 330 determines whether the variation between the current image data and the previous image data is large. That is, the motion determining unit 300 compares the amount of differential data with the threshold value. When the amount of differential data is larger than the threshold value, the motion determining unit 330 attaches a flag indicating a large moving picture frame to the current image data generated on the basis of the differential data.

In step ST210, the image correction processing unit 340 corrects the generated current image frame. That is, the image correction processing unit 340 performs a cross talk correcting process, a ghost correcting process, and a color irregularity correcting process on the generated current image frame.

In step ST220, the driving control unit 350 outputs a control signal to the image projecting unit 360 to display the corrected current image data.

In step ST230, the driving control unit 350 determines whether the current image data is large motion image data. That is, the motion determining unit 330 determines whether a flag indicating the large motion image data is raised to the current image data. When the current image data is small motion image data, not the large motion image data (NO in step ST230), a visibility improving process is not performed, and the image projecting unit 360 is driven to project an image onto the screen 400, thereby displaying the image (step ST240).

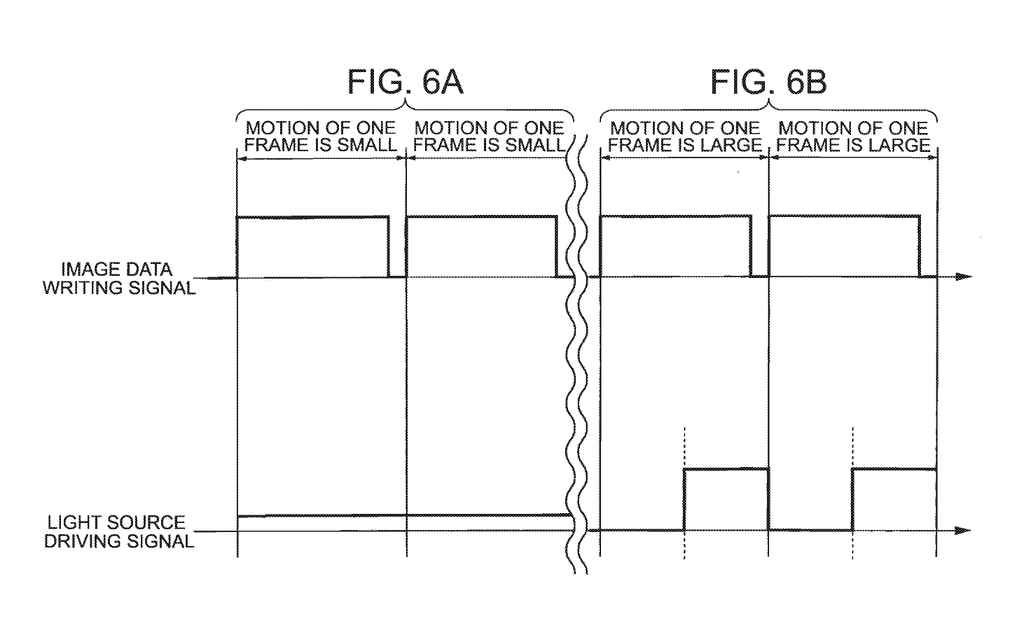

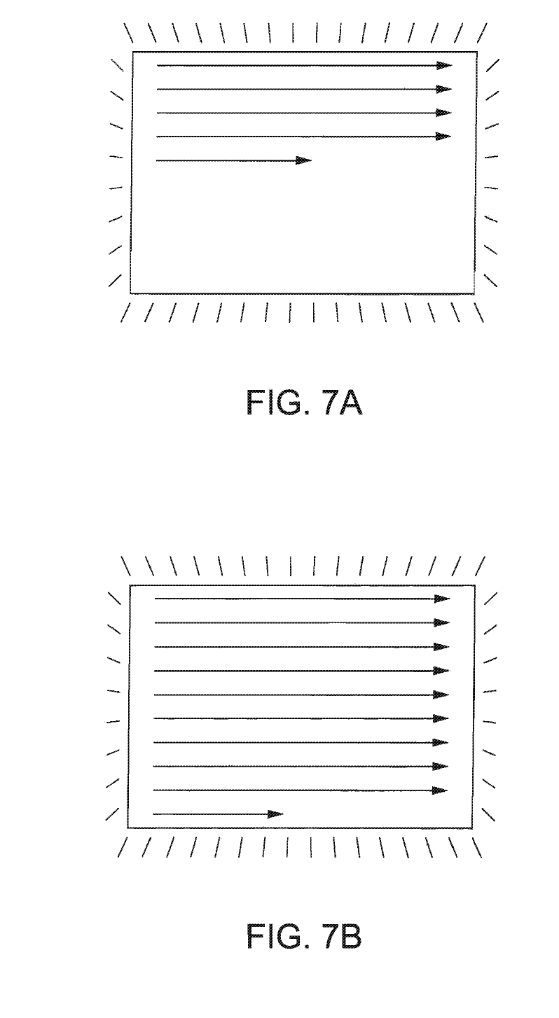

FIG. 6A is a timing chart illustrating signals output from the driving control unit 350 to the image projecting unit 360 at that time. FIGS. 7A and 7B show writing aspects of the liquid crystal panels 372 to 374. That is, when the current image data is small motion image data, not large motion image data, a light source driving signal is always output while an image data writing signal is output, and the intermittent driving of the light source 362 is not performed. That is, as shown in FIGS. 7A and 7B, while the writing of the liquid crystal panels 372 to 374 is performed (FIG. 7A), the light source 362 is kept in an on state.

On the other hand, in step ST230, when the current image data is large motion image data (ST230: YES), the image projecting unit 360 is driven while a visibility improving process is being performed in step ST250, thereby displaying an image (ST240).

That is, as shown in the timing chart of FIG. 6B, the light source driving signal stops in the first half of one frame of a writing signal that is output, and the light source driving signal is output in the second half of the one frame of the signal, which causes the light source 362 to be turned on.

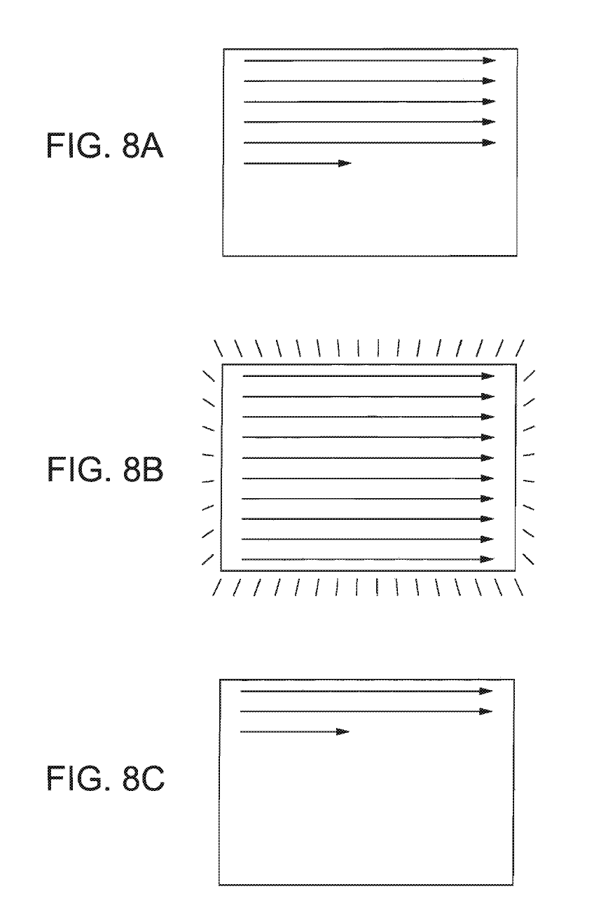

That is, as shown in FIGS. 8A to 8C, the light source 362 is turned off in the first half of the period for which one frame of a signal is written, which is a blanking state (the insertion of black display. The liquid crystal is stabilized in the second half of one frame, which causes the light source 362 to be turned on (FIG. 8B).

When the visibility improving process is performed, in order to uniform brightness, the light source emits light two times as much in inverse proportion to the turn-on time of the light source.

According to the first embodiment having the above-mentioned structure, the following effects can be obtained. (1) The motion determining unit 330 is provided, which makes it possible to determine whether the variation between the current image data and the previous image data is large.

Only when the motion determining unit 330 determines that the current image data is large motion image data, the visibility improving process is performed to improve the visibility of an image.

Only when the current image data which has been determined as the large motion image data by the motion determining unit 330 is displayed, it is possible to display an image whose visibility is improved. Therefore, even when the intermittent driving of the light source 362 is performed as the visibility improving process, it is possible to reduce the load applied to the light source 362 and to appropriately perform the visibility improving process, which makes it possible to improve the display quality of an image.

(2) The differential data is transmitted from the personal computer 200, and the motion determining unit 330 uses the differential data to determine the degree of motion of the current image data.

The differential data is used to reduce the amount of data transmitted between the personal computer 200 and the projector. However, the differential data may be used to determine the degree of motion.

Therefore, in this embodiment, it is possible to easily execute the invention without particularly changing the structure of the personal computer 200.

(3) The personal computer 200 performs a necessary image process and then transmits the image data signal to the projector. Therefore, the projector does not need to have a complicated image processing function, which makes it possible to simplify the structure of the projector.

(4) Since the personal computer 200 is used an information processing apparatus, it is possible to use a graphic processing function of the personal computer 200, and thus it is unnecessary to newly add an image processing function.

The graphic processing function of the personal computer 200 makes it possible to accurately perform image processing at high speed.

(5) Since the differential data, not one image frame, is transmitted from the personal computer 200 to the projector, it is possible to reduce the amounted of transmission data, and thus to appropriately maintain the frame rate of the image displayed by the projector.

### Second Embodiment

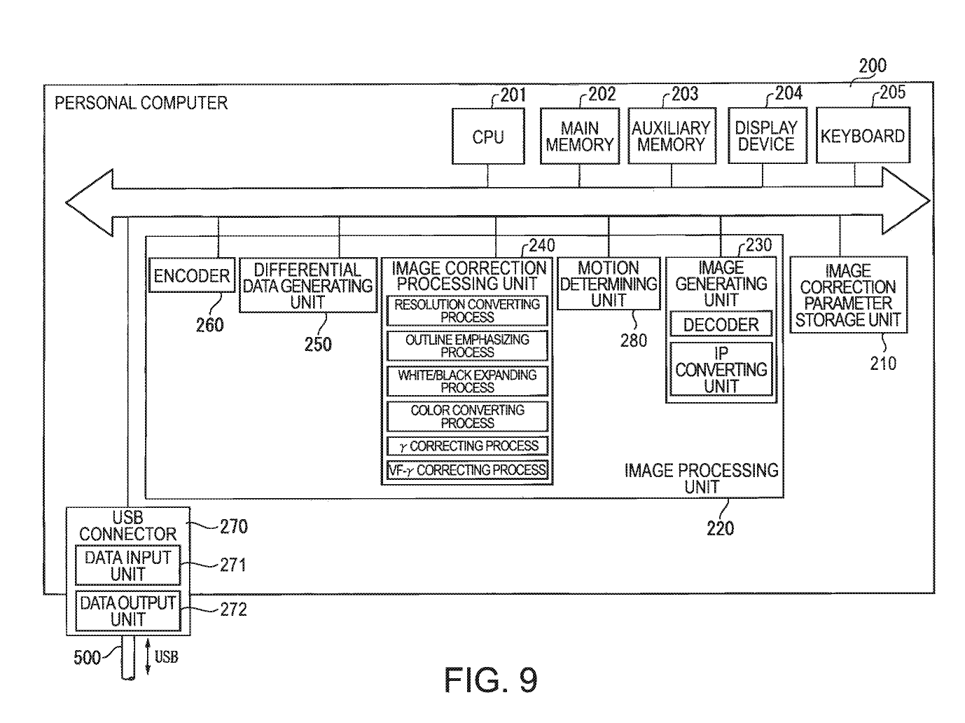

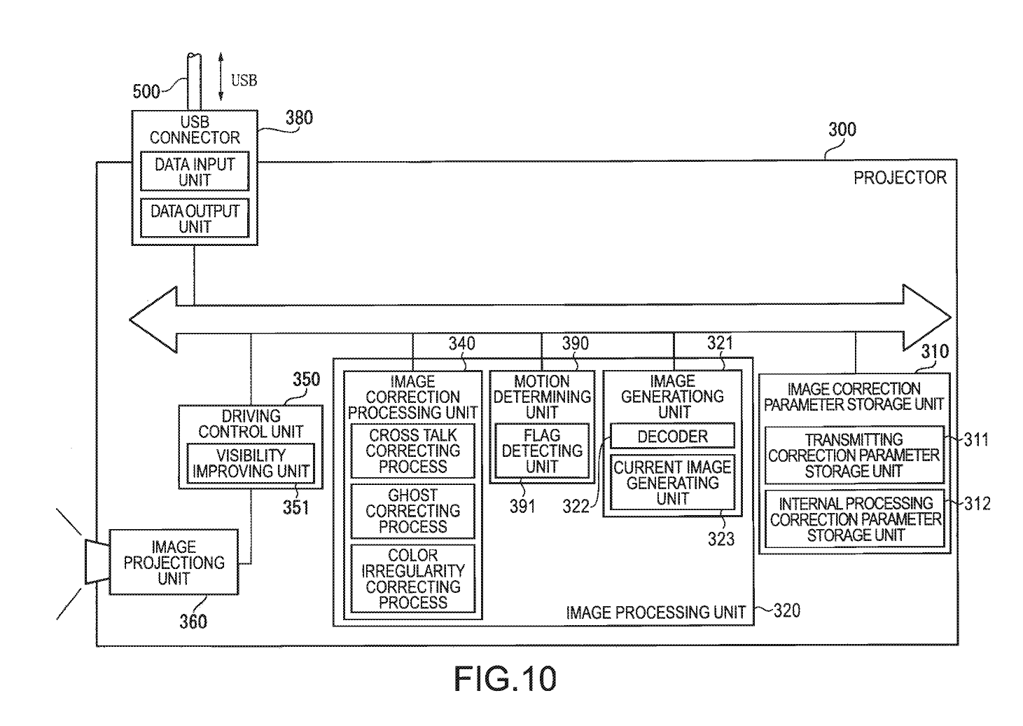

Next, a second embodiment of the invention will be described with reference to FIGS. 9 and 10.

The basis structure of the second embodiment is similar to that of the first embodiment, and the second embodiment is characterized in that a personal computer 200 has a motion determining unit and determines whether the variation between the current image data and the previous image data is large.

FIG. 9 is a block diagram illustrating the structure of the personal computer according to the second embodiment of the invention.

In FIG. 9, the personal computer 200 has a motion determining unit 280.

The motion determining unit 280 determines the degree of variation in the image data decoded by an image generating unit 230, that is, whether the variation between the current image data and the previous image data is large.

In this case, when the motion image data of an image source is represented by, for example, a motion vector on the basis of a predetermined encoding standard, the motion determining unit determines the variation between the current image data and the previous image data on the basis of the magnitude of the motion vector. A predetermined threshold value is set to the motion determining unit, and the threshold value is compared with the magnitude of the motion vector. When the magnitude of the motion vector is larger than the threshold value, it is determined that motion is large, and the current image data generated on the basis of the motion vector is regarded as a large moving picture frame. On the other hand, when the magnitude of the motion vector is smaller than the threshold value, it is determined that motion is small, and the current image data generated on the basis of the motion vector is regarded as a small moving picture frame. In the case of the large moving picture frame data case, a flag is raised to the image data.

Then, an image correction processing unit 240 performs image correction, and a differential data generating unit 250 regards the variation between the current image data and the previous image data as differential data. Subsequently, an encoder 260 encodes the differential data, and transmits the encoded data to the projector through a USB cable 500. These processes in the second embodiment are the same as those in the first embodiment.

FIG. 10 is a functional block diagram illustrating a projector according to the second embodiment of the invention.

In FIG. 10, a motion determining unit 390 includes a flag detecting unit 391.

The flag detecting unit 391 detects the flag raised by the motion determining unit 280 of the personal computer 200. That is, since the motion determining unit 280 of the personal computer 200 raises the flag to the large motion image data, the motion determining unit 390 of the protector 300 recognizes the current image data as the large motion image data when it detects the flag of the image data. When the current image data is recognized as the large motion image data, a visibility improving process is performed when a driving control unit 350 drives an image projecting unit 360.

The second embodiment having the above-mentioned structure can have the same effects as the first embodiment has. Further, the personal computer 200 determines the degree of motion, and the projector performs the detection of the flag, which makes it possible to simplify the structure of a projector.

The invention is not limited to the above-described embodiments, and various modifications and changes of the invention can be made without departing the scope of the invention.

According to the above-described embodiments, in the projection system 100, the personal computer 200 performs main image processing, and then transmits the image data signal to the projector. However, for example, the projection system 100 may include only the projector without the personal computer 200. That is, image data from a source may be directly input to the projector, and the projector may perform image processing and determine the degree of motion. In addition, if necessary, the projector may perform a predetermined visibility improving process and then display an image.

In the first embodiment, the personal computer 200 generates the differential data, and the projector determines the degree of motion on the basis of the amount of differential data.

Alternatively, for example, the personal computer 200 may include a differential data generating unit and a motion determining unit that determines a variation in current image data on the basis of the magnitude of the differential data generated by the differential data generating unit. The motion determining unit may determine the degree of motion of the current image data and raise a flag. The projector may include a motion detecting unit that detects whether a flag exists.

According to this structure, the projector may not determine the degree of motion on the basis of the differential data, which makes it possible to simplify the structure of the projector.

Both the spatial variation and the color variation between the current image data and the previous image data may be used as the differential data. Alternatively, the spatial variation between the current image data and the previous image data may be used as the differential data, and the color variation between the current image data and the previous image data may be used as color data of an image, not the differential data.

In the above-described embodiments, the projector for projecting an image onto the screen 400 is used as the image display apparatus, but the invention is not limited thereto. For example, a liquid crystal display panel may be used as the image display apparatus.

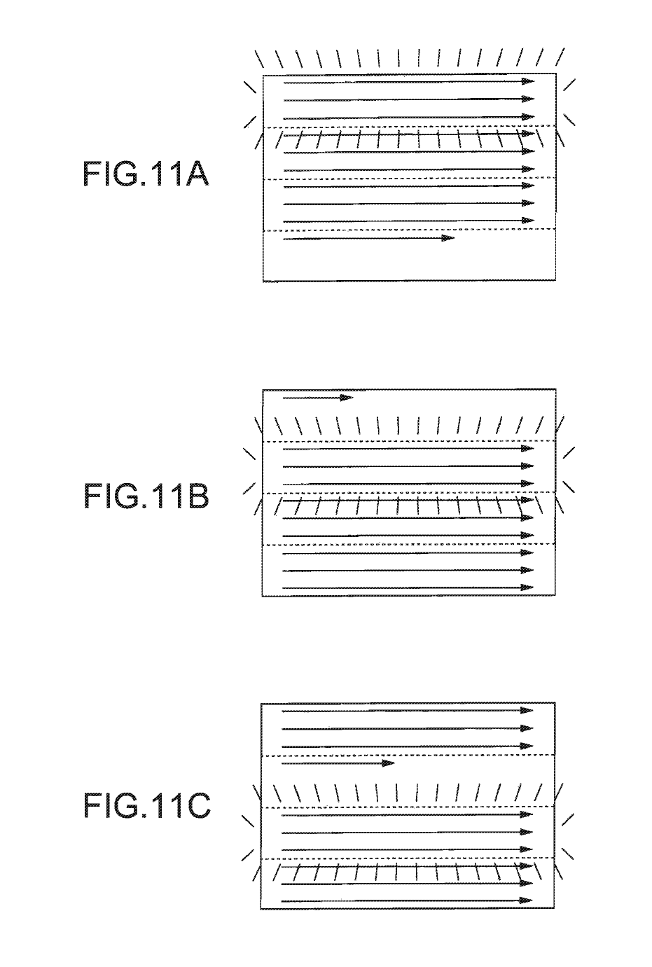

In the visibility improving process described with reference with FIG. 6B and FIGS. 8A to 8C, black display is inserted in the entire liquid crystal panel in the first half of the period for which one frame is displayed, but the invention is not limited thereto. For example, in the visibility improving process, as shown in FIGS. 11A to 11C, a liquid crystal panel may be divided into a plurality of regions, and a light source may be provided in each region. Then, the writing timing of the region and the turn-on timing of the light source may deviate from each other, thereby performing black display in each region.

The invention can be applied to, for example, a projector and a projection system.

The entire disclosure of Japanese Patent Application No. 2005-273707, filed Sep. 21, 2005 is expressly incorporated by reference herein.

What is claimed is:

1. An image display apparatus that displays input image data, comprising:
a light source unit;
a light modulating device that has liquid crystal elements arranged in a matrix, each modulating light emitted from the light source unit in response to a driving signal in every pixel;
a driving control unit that controls the driving of the light source unit and the light modulating unit;
a motion determining unit that compares a variation between current image data and previous image data with a predetermined threshold value, sets the current image data to large motion image data when the variation is larger than the threshold value, and sets the current image data to small motion image data when the variation is smaller than the threshold value; and
a visibility improving unit that drives the driving control unit to perform a visibility improving process when the current Image data that has been determined as the large motion image data by the motion determining unit is displayed.

2. The image display apparatus according to claim 1,
wherein the visibility improving unit intermittently drives the light source unit while one frame of image data is being displayed, thereby inserting black display in the one frame.

3. A projection system comprising:
an information processing apparatus that performs predetermined image processing on an input image source to output an image data signal;
an image display apparatus that includes a light source unit, a light modulating device which has liquid crystal elements arranged in a matrix, each modulating light emitted from the light source unit in response to a driving signal in every pixel, and a driving control unit which controls the driving of the light source unit and the light modulating unit, and displays the image source input from the information processing apparatus; and
a signal transmitting unit that transmits signals between the information processing apparatus and the image display apparatus,
wherein the information processing apparatus includes a differential data generating unit that compares current image data with previous image data and detects a variation between the current image data and the previous image data as differential data, and the image display apparatus includes:
a motion determining unit that compares the amount of the differential data with a predetermined threshold value, sets the current image data to large motion image data when the amount of the differential data is larger than the threshold value, and sets the current image data to small motion image data when the amount of the differential data is smaller than the threshold value; and
a visibility improving unit that drives the driving control unit to perform a visibility improving process when the current image data that has been determined as the large motion image data by the motion determining unit is displayed.

4. A projection system comprising:
an information processing apparatus that performs predetermined image processing on an input image source to output an image data signal;
an image display apparatus that includes a light source unit, a light modulating device which has liquid crystal elements arranged in a matrix, each modulating light emitted from the light source unit in response to a driving signal in every pixel, and a driving control unit which controls the driving of the light source unit and the light modulating unit, and displays the image source input from the information processing apparatus; and
a signal transmitting unit that transmits signals between the information processing apparatus and the image display apparatus,
wherein the information processing apparatus includes a motion determining unit that compares a variation between current image data and previous image data, and raises a flag for allowing the current image data to be set to large motion image data when the variation is larger than the threshold value, and
the image display apparatus includes:
a flag detecting unit that detects the flag raised by the motion determining unit; and
a visibility improving unit that drives the driving control unit to perform a visibility improving process when the current image data that has been determined as the large motion image data by the motion determining unit is displayed.
